(19) United States
(12) Patent Application Publication
(10) Pub. No.: US 2014/0117183 A1
(43) Pub. Date: May 1, 2014

(54) Beverage Container Holder for Attachment to a Urinal

(71) Applicant: Robert McClure, Golden, CO (US)

(72) Inventor: Robert McClure, Golden, CO (US)

(21) Appl. No.: 13/662,170

(22) Filed: Oct. 26, 2012

(51) Int. Cl. A47G 23/02; B23P 25/00; B29C 45/00

(52) U.S. Cl. 248/311.2; 264/328.1; 29/527.1

(57) ABSTRACT

A beverage container holder configured to mounting to a flush valve of a urinal for the purpose of holding a beverage, such as a bottle of beer, is described. The holder mounts to a tailpiece nut of the flush valve by way of a tailpiece connector that both securely holds the container in place to prevent undesirable upwardly and downwardly motion as well as side to side motion.

### FIELD OF THE INVENTION

The invention pertains to devices for holding a beverage container holder.

### BACKGROUND

A common problem for a man in a nightclub or bar concerns what to do with his drink when he enters the establishment's public bathroom to urinate in a urinal. If the drink is left unattended outside of the bathroom, such as on a table or the top of the bar, a waitress or bartender may dispose of the beverage believing it has been abandoned. If the drink is taken into the bathroom, he will likely have to hold the drink in one hand or under an arm while he manipulates his pants and relieves himself. As is obvious to most men, holding a drink while urinating increases the risk of an undesirable event, such as but not limited to dropping or spilling the drink.

Solutions to the foregoing problem have been proposed and include small shelf units and coasters that are mounted to one or both of the urinal and its flush valve. Several patents applications have been filed and several patents issued describing these devices, which most commonly attach over or replace the flush valve cap. Generally these solutions do not fully support the beverage container but merely provide a flat surface upon which to rest the container. If the container is knocked while resting on the coaster or shelf, the beverage container may fall. Further, the stability of some of the proposed solutions are suspect depending on how they are mounted thereby hampering their practical usability. These solutions have not been readily adopted in the marketplace.

Another solution known in the art is to place a shelf over the top of one or a series of urinals. This solution is particularly popular in bathrooms within ski area lodges as it gives the user a place to put his gloves while urinating. Installation of a shelf can be time consuming and requires drilling and fastening to a wall surface. Obstructions, such a plumbing, may make the positioning of the shelf inconvenient. Further, if the wall is covered in tile, special care that adds to the installation expense must be taken. While above-urinal shelves are relatively popular at ski areas, they have not been widely adopted at nightclubs, bars and restaurants.

### BRIEF DESCRIPTION OF THE DRAWINGS

FIG. 1 is an isometric side view of a beverage container holder for attachment to a flush valve assembly of a urinal accordingly to one embodiment of the present invention.

FIG. 2 is an isometric top view of the beverage container holder of FIG. 1 according to one embodiment of the present invention.

FIG. 3 is an isometric bottom view of the beverage container holder of FIG. 1 according to one embodiment of the present invention.

FIG. 4 is a cross sectional view of the strap portion of the FIG. 3 beverage container holder taken along line 4-4 as shown in FIG. 3 according to one embodiment of the present invention.

FIG. 5 is a front view of a urinal flush valve as is known in the art.

FIG. 6 is an isometric view of the beverage container holder with a strap portion wrapped and secured around a tailpiece nut of a urinal flush valve according to one embodiment of the present invention.

FIG. 7 is an exploded view of another embodiment of a beverage container holder wherein the strap portion and the receptacle portion comprise separate components.

### DETAILED DESCRIPTION

Embodiments of the invention comprise a container holder configured to mounting to a flush valve of a urinal for the purpose of holding a beverage, such as a bottle of beer. Several embodiments mount to a tailpiece nut of the flush valve assembly, which both securely holds the container in place to prevent undesirable upwardly and downwardly motion as well as side to side motion.

The holder's beverage receptacle includes a relatively high sidewall that substantially prevents a bottle or cup received therein from being inadvertently knocked over spilling its contents. The bottom of the receptacle includes perforations or holes that inhibit liquid, such as condensation, from pooling. The outside of the sidewall of the receptacle also provides significant surface area on which advertising or other indicia can be placed.

An attachment means is either integrally formed with the holder or a separate component that interfaces or mates with the receptacle. In at least some embodiments, the attachment means comprises a strap assembly (or portion) that wraps around the tailpiece nut of a typical urinal flush valve and is secured in place by an associated nut and an associated bolt. Variations of the strap assembly include straps with downwardly extending vertical flanges that effectively prevents the side to side movement of the container and helps secure it in place.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, tense or any singular or plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of phrases like “in one embodiment”, “in an embodiment”, or “in a variation” in various places in the specification are not necessarily all meant to refer to the same embodiment or variation.

The term “integrate” or “integrated” as used in this specification and the appended claims refers to a blending, uniting, or incorporation of the identified elements, components or objects into a unified whole.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

As applicable, the terms “about” or “generally” as used herein unless otherwise indicated means a margin of +−20%. Also, as applicable, the term “substantially” as used herein unless otherwise indicated means a margin of +−10%. It is to be appreciated that not all uses of the above terms are quantifiable such that the referenced ranges can be applied and as such where the indicated margins are not readily applicable, the foregoing terms have meanings attributable to them as would be understood by someone of ordinary skill in the art given the benefit of this disclosure.

### A First Embodiment of a Beverage Container Holder for Attachment to a Urinal

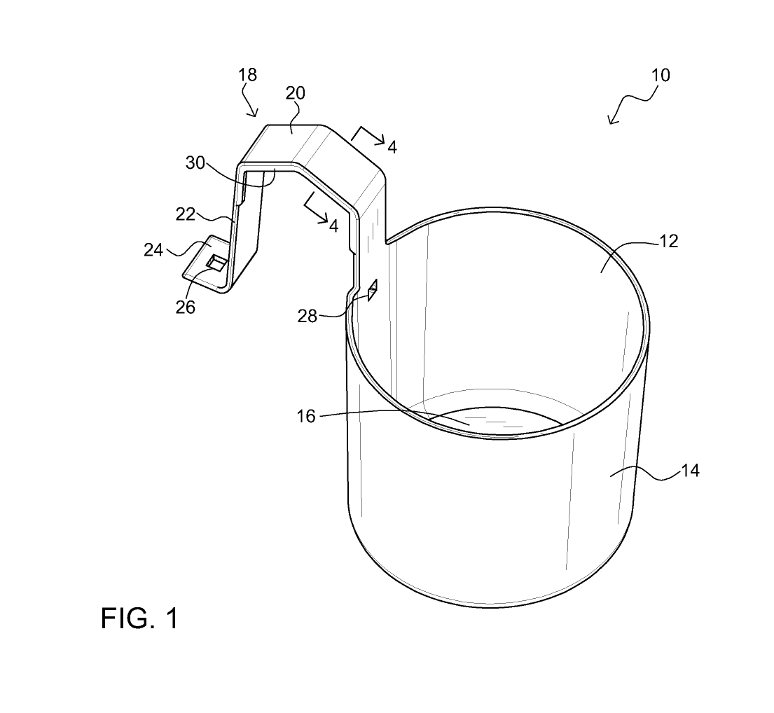

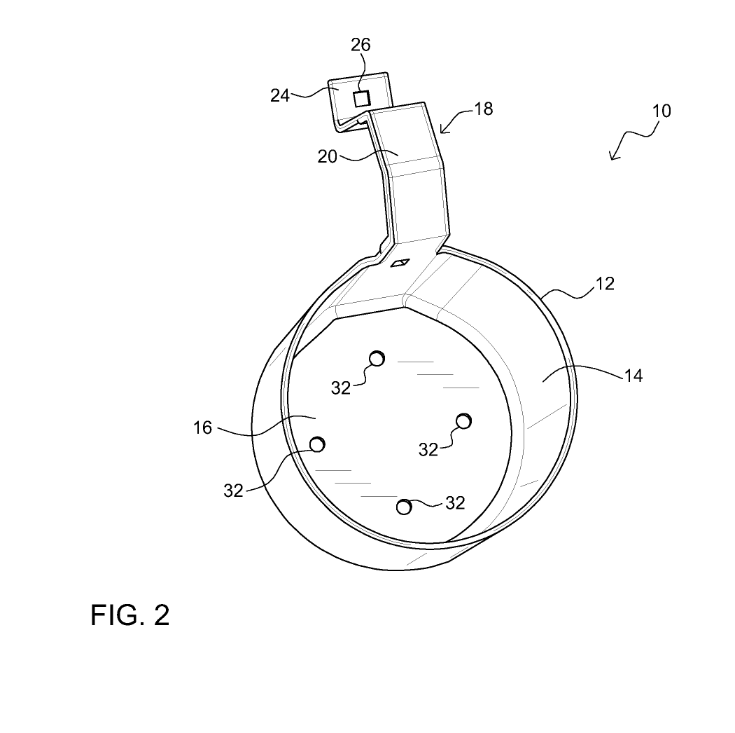

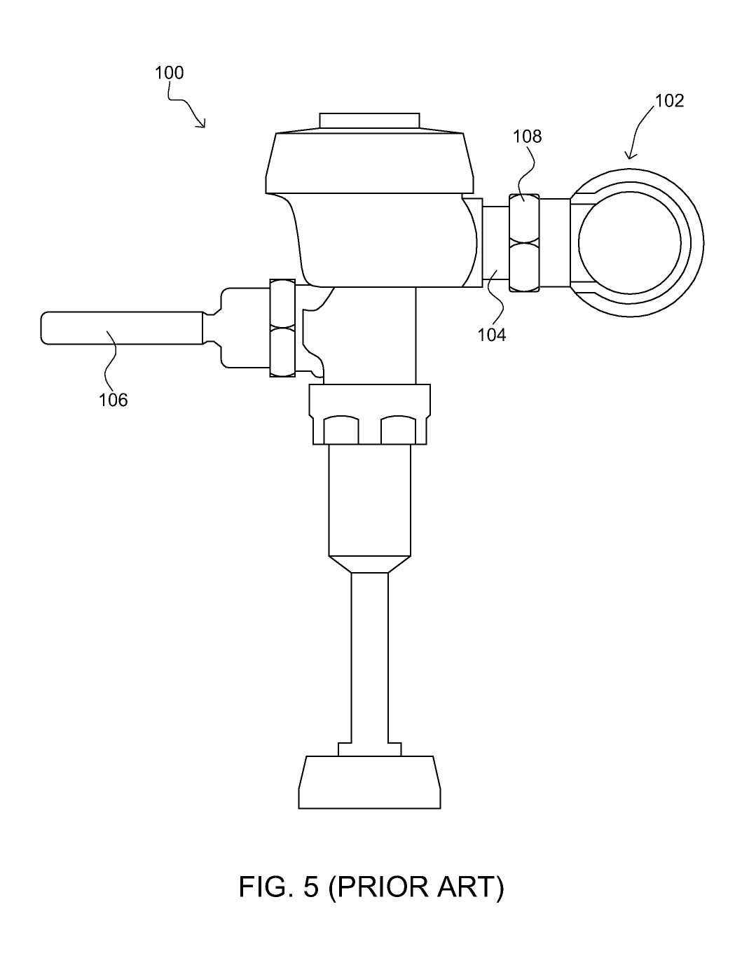

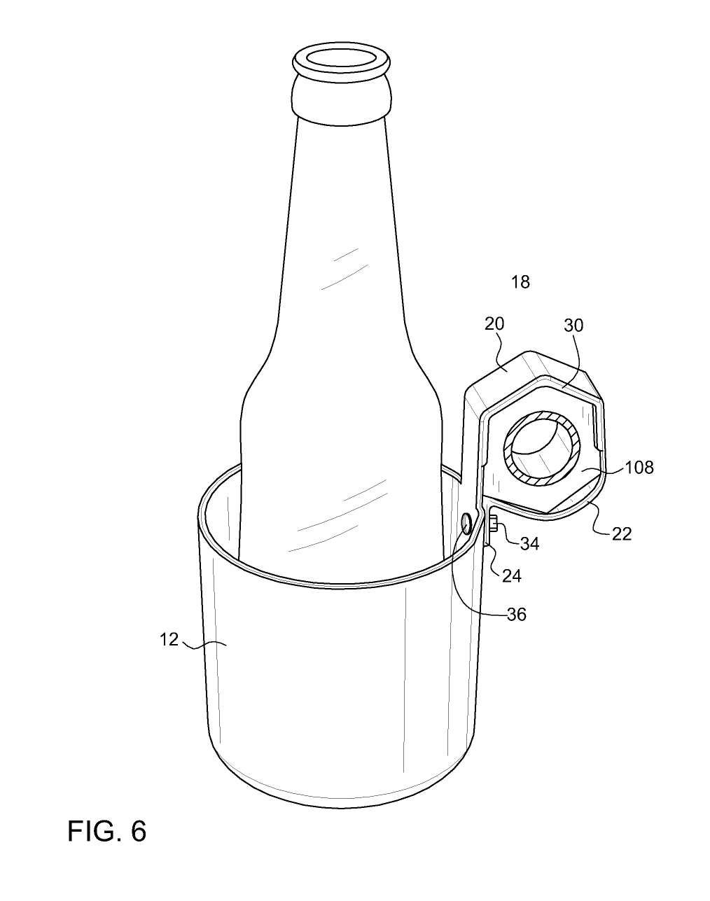

FIGS. 1-4 illustrate a first embodiment beverage container holder 10 configured for attachment to the tailpiece nut 108 (see FIGS. 5 & 6) of a urinal flush valve. The holder includes: (i) a receptacle 12 adapted and configured to receive a beverage container therein, such as a beer bottle; (ii) a tailpiece connector 18 integrally molded with the receptacle and configured to be received and secured around tailpiece nut; and (iii) a nut 34 and bolt 36 (see FIG. 6) for holding the strap portion in its secured position.

As illustrated, the receptacle 12 is substantially cylindrical having an arcuate sidewall 14 and a bottom 16. The bottom typically includes one or more holes 32 or perforations to permit any liquid, such as condensation, from pooling in the receptacle. The integrally formed receptacle along the holder is typically comprised of a polymeric material such as but not limited to polypropylene and polyethylene.

The tailpiece nut connector 18, which is integrally formed with the receptacle, extends upwardly from a top edge of the receptacle and comprises several distinct portions 20, 22 & 24.

The first portion 20 includes four planar sections that are interconnected at their ends at an acute angle of about 60 degrees. The planar sections are adapted to sit on top of and cover the top portion of a tailpiece nut 108 which is typically hexagonal. The first planar section extends generally vertically upwardly from a first end that interfaces with the receptacle and has a second end opposite the first end as well as opposing left and right edges. The second planar section has a first end, a second end opposite the first end and opposing left and right edges. The first end of the second planar section intersects with the second end of the first planar section at about a 60 degree angle. The third planar section has a first end, a second end opposite the first end and opposing left and right edges. The first end of the third planar section intersects with the second end of the second planar section at a substantially 60 degree angle. The fourth planar section extends generally vertically downwardly and has a first end, second end opposite the first end and opposing left and right edges. The first end of the fourth planar section intersects with the second end of the third planar section at a substantially 60 degree angle. As is clear from the figures, the first, second, third and fourth planar sections taken together form a partial hexagonal shape. As best shown in FIG. 6, the four flat sections substantially cover four sides of the tailpiece nut.

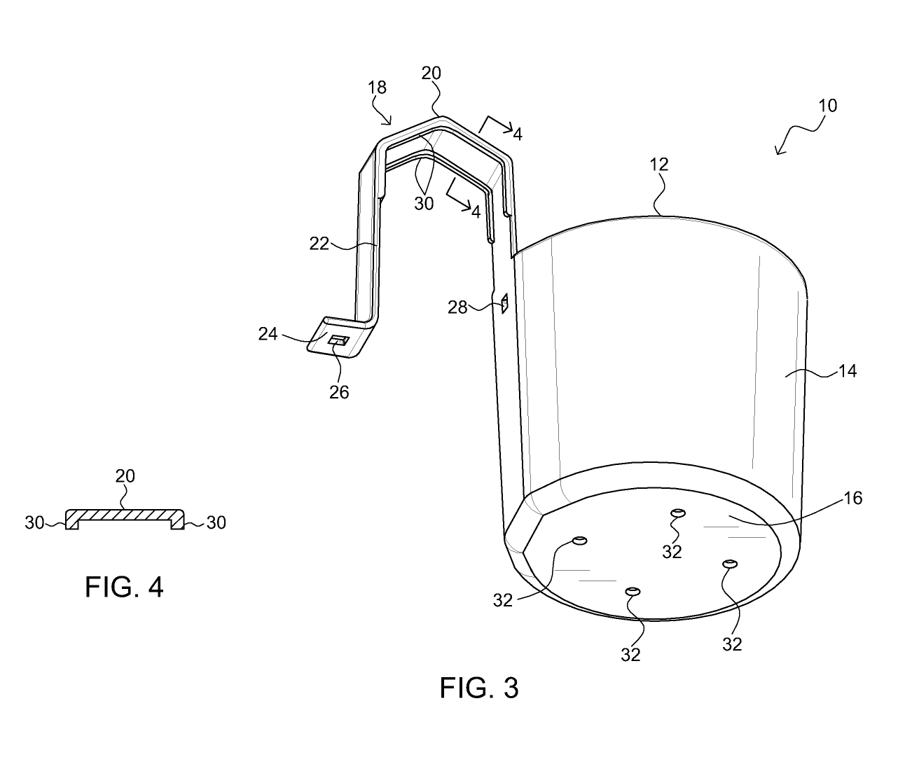

At the edges of the planar sections of the first portion, as best seen in FIG. 3 and the cross section of FIG. 4, flanges 30 extend inwardly orthogonally to the face of each respective flange's adjacent planar sections at their respective left and right edges. As can be appreciated, the width of the planar sections between opposing flanges is typically slightly greater than the width of the tailpiece nut on which the first portion 20 rests. Accordingly when the strap portion is secured in place as best shown in FIG. 6 around the tailpiece nut 108, it is inhibited from sliding off the nut to the left or the right. Additionally, the four planar sections, which are made generally rigid by the stiffening effect of the flanges, hold the holder in position on the nut substantially preventing the rotational movement of the holder relative to the tailpiece nut center axis.

The second portion 22 (also referred to as the strap portion) of the tailpiece connector 18 extends substantially vertically downwardly from a first edge intersecting with the transverse edge of the fourth planar section as seen in FIG. 3 and terminates at a second or distal edge. Unlike the first portion, the second portion is resilient and flexible and has no flanges and is configured to wrap around the bottom half of the tailpiece net as best shown in FIG. 6.

The third portion 24 comprises a relative small flat section that extends generally orthogonally from the distal end of the second portion 22 and is characterized by an opening formed proximate its center for the receipt of a fastener or bolt 36 therein. The hole is configured to correspond to a similar hole 28 or opening in the sidewall 14 of the receptacle such that when the second portion is wrapped around a tailpiece nut 108, the third portion interfaces with outside of the sidewall around the sidewall hole and the securing bolt can received through both holes. As shown the holes have square or rectangular configurations and are adapted to receive a bolt therein that has a square section below its head. The squares holes interact with the square section of the bolt to prevent rotation thereof as the nut 34 is tightened onto the bolt.

FIG. 5 is an illustration of a standard prior art urinal flush valve 100. As shown, flush values typically include a flush lever 106 although some automated valves are activated by electronic motion sensors. The valve itself connects to a water supply outlet 102 by way of a tailpiece pipe 104 that is secured to the outlet be the tailpiece nut 108. The tailpiece nut is typically of a standard size as is the tailpiece to mount to standard size water supply outlets. The strap portion 18 is configured to mate with the standard sized nut but it is appreciated that the size of the strap portion can vary in alternatives to accommodate tailpiece nuts of varying sizes and configurations. For instance, a variation of the holder can be produced wherein the size of the strap portion is larger or smaller as necessary to accommodate larger or small hexagonal shaped tailpiece nuts. Other variations can be produced to interface with tailpiece nuts that are other than hexagonal, such as a four sided nut.

### A Second Embodiment of a Beverage Container Holder for Attachment to a Urinal

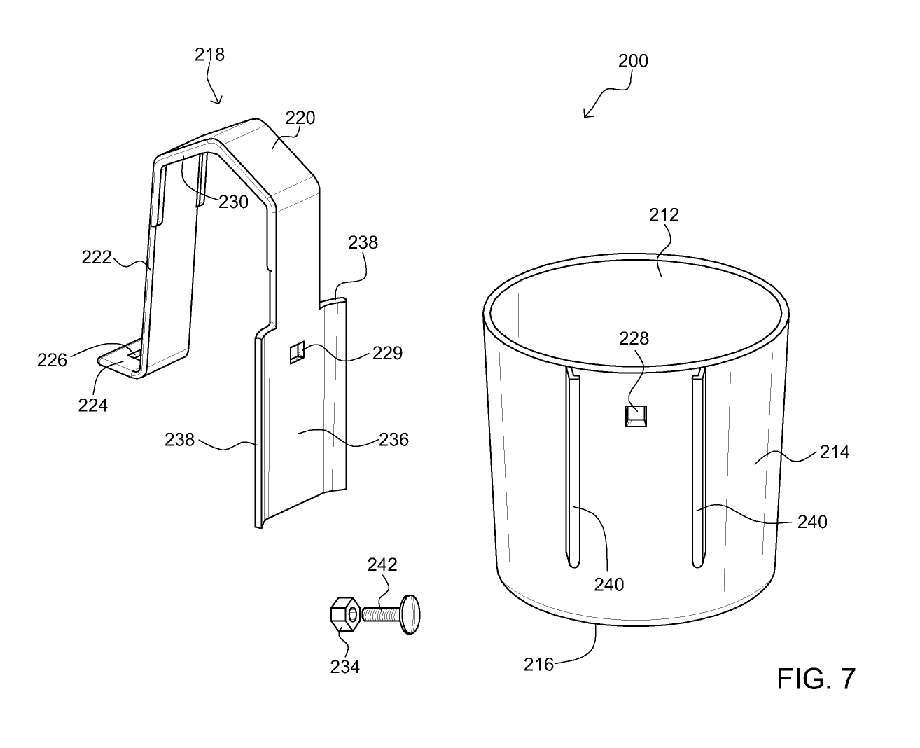

FIG. 7 is an exploded view of a second embodiment beverage container holder for attachment to a urinal that is generally similar to the first embodiment except the tailpiece nut connector is separately fabricated and distinct from the receptacle. Essentially, the second embodiment comprises (i) a receptacle 212, (ii) the tailpiece nut connector 218, and (iii) a nut 134 and bolt 236 to both secure the strap portion and the holder to a tailpiece nut and also to further secure the strap component to the receptacle.

Where the last two digits of an element number in FIG. 7 correspond to an element in FIGS. 1-4 & 5, the associated elements substantially the same, and as such, each of these elements need not be described again below. As mentioned the primary differences between the first and second embodiment is that the tailpiece nut connector in the second embodiment is separately manufactured from the receptacle and is married to the receptacle in a later assembly operation.

The tailpiece nut connector 218 includes a fourth portion 236 when compared to the tailpiece nut connector of the first embodiment. The fourth portion extends downwardly from the proximal end of the first portion 220 and is wider than the first portion because of the addition of a pair of opposing wing members 238. As shown in FIG. 7, the inside surface of the winged fourth portion is arcuate having an effective radius of curvature that generally matches that of the outside surface of the receptacle. A hole is provided in the fourth portion through which the securing bolt is received.

The receptacle 212 includes a pair of vertically-extending slots 240 that face each other and flank the receptacle's bolt hole opening 228. To join the receptacle and the tailpiece nut connector, the wings 238 of the fourth portion are slid into the opposing slots. The first portion 220 of the tailpiece nut connector is placed over the desired tailpiece nut 108 and the second portion is wrapped around the bottom of the nut until all three bolt holes 226, 228 & 229 are aligned. To finally secure the joined combination to the urinal flush valve, the bolt 242 is placed through the bolt holes and the nut 234 is threaded and tightened in place.

### A Method of Making a Beverage Container Holder for Attachment to a Urinal

The various embodiments of the cup holder can be made from any number of materials; however, usually the holder is comprised of a plastic material. The first embodiment is injection molded in a single operation; whereas, the two plastic components of the second embodiment are separately molded. The second embodiment strap component is typically injection molded while the receptacle can by vacuum molded as well. The various holes or perforations can and are typically formed in the holder during molding although in some variations that can be added in a separate post-molding operation.

### A Method of Using a Beverage Container Holder Attached to a Urinal

Initially, the holder is installed on a tailpiece nut of a urinal. This entails placing the top of the strap portion over the nut so that it rests thereon with the receptacle in a generally vertically-disposed orientation. As can be appreciated, it may be necessary to tighten slightly or readjust the orientation of the tailpiece nut before installing the holder to help ensure the receptacle is properly orientated.

Next, the installer wraps the second sub-portion of the strap around the bottom of the nut bringing the bolt hole 26 of the third sub-portion 24 in alignment with the bolt hole 28 in the receptacle. The bolt 36 is placed through the holes and a nut is threaded and tightened onto the bolt to secure the strap and ultimately fix the holder in place on the flush valve.

To use the holder a user places his beverage container, such as a bottle of beer, into the holder while doing one's business at the urinal. Any condensation or beverage spillage drains outside the bottom of the receptacle to avoid the pooling of stagnant liquid that could become unsanitary or require an extra cleaning step by the janitorial staff.

On some variations of the holder, indicia are provided on the outside surface of the receptacle. The indicia typically comprise advertising. Given the location of the holder and the nature of a urinal, users of the urinal will likely notice and review the marketing material while relieving themselves regardless of whether they have placed a beverage container in the holder.

### Other Embodiments and Variations

The various preferred embodiments and variations thereof illustrated in the accompanying figures and/or described above are merely exemplary and are not meant to limit the scope of the invention. It is to be appreciated that numerous variations to the invention have been contemplated as would be obvious to one of ordinary skill in the art with the benefit of this disclosure.

I claim:

1. A beverage container holder configured for attachment to a tailpiece nut of a urinal flush valve, the beverage holder comprising:
a receptacle adapted to selectively receive a beverage container therein; and
a tailpiece nut connector, the tailpiece nut connector coupled with the receptacle and adapted to be secured to the tailpiece nut.

2. The beverage container holder of claim 1, wherein the tailpiece nut connector comprises a top portion comprising four substantially planar sections:
(i) a first planar section extending generally vertically upwardly from a first end, the first planar section having a second end opposite the first end and opposing left and right edges;
(ii) a second planar section having a first end, a second end opposite the first end and opposing left and right edges, the first end intersecting with the second end of the first planar section at a substantially 60 degree angle;
(iii) a third planar section having a first end, a second end opposite the first end and opposing left and right edges, the first end intersecting with the second end of the second planar section at a substantially 60 degree angle; and
(iv) a fourth planar section extending generally vertically downwardly having a first end, second end opposite the first end and opposing left and right edges, the first end intersecting with the second end of the third planar section at a substantially 60 degree angle;
wherein the first, second, third and fourth planar sections taken together form a partial hexagonal shape.

3. The beverage container holder of claim 2 wherein: (i) at least one of the left edges of the respective first, second third and fourth planar sections includes a left flange that extends orthogonally inwardly relative to the surface of the associated planar section; and (ii) at least one of the right edges of the respective first, second third and fourth planar sections includes a right flange that extends orthogonally inwardly relative to the surface of the associated planar section.

4. The beverage container holder of claim 2 wherein each of the right and left edges of the first, second, third and fourth planar sections include respective right and left flanges, each flange extends orthogonally inwardly relative to the surface of the associated planar section.

5. The beverage container holder of claim 2 wherein each of the right and left edges of the second and third planar sections include respective right and left flanges, each flange extends orthogonally inwardly relative to the surface of the associated planar section.

6. The beverage container holder of claim 3 wherein the tailpiece nut connector further comprises a resilient strap section intersecting with and extending from the second end of the fourth planar section, the resilient strap section including at its distal end a section including a bolt hole opening.

7. The beverage container holder of claim 6 wherein the tailpiece nut connector is integrally and unitarily molded with the receptacle.

8. The beverage container holder of claim 6, wherein the receptacle and the tailpiece nut connector are separately fabricated and coupled together in a subsequent manufacturing operation.

9. The beverage container holder of claim 8 wherein the receptacle and the tailpiece connector are injection molded from a polymeric material.

10. The beverage container holder of claim 1 including an outside surface, the outside surface having indicia printed thereon.

11. The beverage container holder of claim 1, wherein the receptacle includes a bottom side and the bottom side has one or more holes passing therethrough.

12. A method of making the beverage container holder of claim 1, the method comprising integrally molding the holder from a polymeric material.

13. A method of making the beverage container holder of claim 1, the method comprising separately molding the receptacle and the tailpiece nut connector from plastic and mechanically joining the receptacle and the tailpiece nut connector togethor.

14. A method of using the beverage container holder of claim 1, the method comprising: (i) securing the beverage holder to the tailpiece nut of the urinal flush valve; and (ii) placing a beverage container in the holder.

15. The beverage container holder of claim 1 in combination with a urinal having the flush valve wherein the tailpiece nut connector is secured to the tailpiece nut.

16. The combination of claim 14, further including a beverage, the beverage being received in the receptacle.

17. A beverage container holder configured for attachment to a tailpiece nut of a urinal flush valve, the beverage container holder comprising:
a receptacle adapted to selectively receive a beverage container therein, the receptacle including a bottom side, the bottom side having one or more holes passing therethrough;
and
a tailpiece nut connector, the tailpiece nut connector coupled with the receptacle and adapted to be secured to the tailpiece nut, the tailpiece comprising,
(1) a top portion comprising four substantially planar sections , (a) a first planar section extending generally vertically upwardly from a first end, the first planar section having a second end opposite the first end and opposing left and right edges, (b) a second planar section having a first end, a second end opposite the first end and opposing left and right edges, the first end intersecting with the second end of the first planar section at a substantially 60 degree angle, (c) a third planar section having a first end, a second end opposite the first end and opposing left and right edges, the first end intersecting with the second end of the second planar section at a substantially 60 degree angle and (d) a fourth planar section extending generally vertically downwardly having a first end, second end opposite the first end and opposing left and right edges, the first end intersecting with the second end of the third planar section at a substantially 60 degree angle, wherein the first, second, third and fourth planar sections taken together form a partial hexagonal shape, and wherein each of the right and left edges of the first, second, third and fourth planar sections include respective right and left flanges, each flange extends orthogonally inwardly relative to the surface of the associated planar section,
(2) a resilient strap section intersecting with and extending from the second end of the fourth planar section, the resilient strap section including at its distal end a section including a bolt hole opening;
wherein the beverage container holder is comprised substantially of a polymeric material.

18. The beverage container holder of claim 17, wherein the receptacle and the tailpiece nut connector are separately fabricated and coupled together in a subsequent manufacturing operation.
